(19) United States
(12) Patent Application Publication
(10) Pub. No.: US 2016/0226312 A1
(43) Pub. Date: Aug. 4, 2016

(54) WIRELESS POWER RECEPTION SYSTEM, WIRELESS POWER TRANSMISSION SYSTEM, CONTROL METHOD, COMPUTER PROGRAM, AND RECORDING MEDIUM

(71) Applicant: PIONEER CORPORATION, Kanagawa (JP)

(72) Inventor: Masami SUZUKI, Kawasaki-shi, Kanagawa-ken (JP)

(21) Appl. No.: 14/914,919

(22) PCT Filed: Aug. 30, 2013
(86) PCT No.: PCT/JP2013/073342

§ 371 Date: Feb. 26, 2016

(51) Int. Cl. H02J 50/12

(52) U.S. Cl. CPC H02J 50/12

(57) ABSTRACT

A wireless power reception system is provided with: a power reception antenna configured to receive, in a wireless manner, electric power outputted from a power transmission antenna of a power transmitting apparatus; a rectifier electrically connected between the power reception antenna and a load, the load being supplied with the electric power received by the power reception antenna; a constant voltage circuit electrically connected between the rectifier and the load; an obtaining device configured to obtain input impedance associated with the constant voltage circuit; and a controlling device configured to calculate an output adjustment value associated with the power supply on the basis of the obtained input impedance and to transmit the calculated output adjustment value to the power transmitting apparatus.

### TECHNICAL FIELD

The present invention relates to a wireless power reception system and a wireless power transmission system in which electric power can be transmitted in a wireless or noncontact manner, a control method in the wireless power reception system, a computer program, and a recording medium on which the computer program is recorded.

### BACKGROUND ART

In this type of system, impedance changes due to a variation in distance (i.e. a gap) between a power transmission side antenna and a power reception side antenna, a change in charging state of a battery when a load electrically connected to a power reception side is the battery, and a circuit load variation.

Thus, for example, Patent Literature 1 describes a technology in which an electric power conversion unit provided with a DC-DC converter is provided between a secondary side (or power reception side) antenna and a battery, and in which duty of the DC-DC converter is controlled to perform impedance matching.

### CITATION LIST

### Patent Literature

### Patent Literature 1: Japanese Patent Application Laid Open No. 2011-120443

### SUMMARY OF INVENTION

### Technical Problem

In the technology described in the Patent Literature 1, however, if the duty of the DC-DC converter changes, output voltage of the DC-DC converter also changes. Then, there is such a technical problem that constant voltage output characteristics cannot be obtained, which is required for a power supply to which the load such as, for example, the battery, is electrically connected.

In view of the aforementioned problem, it is therefore an object of the present invention to provide a wireless power reception system, a wireless power transmission system, a control method, a computer program, and a recording medium, in which the constant voltage output characteristics can be maintained even if the power reception side load changes in the wireless power transmission system.

### Solution to Problem

The above object of the present invention can be achieved by a wireless power reception system is provided with: a power reception antenna configured to receive, in a wireless manner, electric power outputted from a power transmission antenna of a power transmitting apparatus, which comprises a power supply and the power transmission antenna electrically connected to the power supply; a rectifier electrically connected between the power reception antenna and a load, the load being supplied with the electric power received by the power reception antenna; a constant voltage circuit electrically connected between the rectifier and the load; an obtaining device configured to obtain input impedance associated with the constant voltage circuit; and a controlling device configured to calculate an output adjustment value associated with the power supply on the basis of the obtained input impedance and to transmit the calculated output adjustment value to the power transmitting apparatus.

The above object of the present invention can be achieved by a wireless power transmission system comprising a power transmitting apparatus and a power receiving apparatus electrically connected to a load, wherein the power transmitting apparatus is provided with: a power supply; a power transmission antenna electrically connected to the power supply; and a power supply controlling device configured to control the power supply, the power receiving apparatus is provided with: a power reception antenna configured to receive, in a wireless manner, electric power outputted from the power transmission antenna; a rectifier electrically connected between the power reception antenna and the load; a constant voltage circuit electrically connected between the rectifier and the load; an obtaining device configured to obtain input impedance associated with the constant voltage circuit; and a controlling device configured to calculate an output adjustment value associated with the power supply on the basis of the obtained input impedance and to transmit the calculated output adjustment value to the power transmitting apparatus, and the power supply controlling device controls the power supply on the basis of the transmitted output adjustment value.

The above object of the present invention can be achieved by a control method in a wireless power reception system is provided with: (i) a power reception antenna configured to receive, in a wireless manner, electric power outputted from a power transmission antenna of a power transmitting apparatus, which comprises a power supply and the power transmission antenna electrically connected to the power supply; (ii) a rectifier electrically connected between the power reception antenna and a load, the load being supplied with the electric power received by the power reception antenna; and (iii) a constant voltage circuit electrically connected between the rectifier and the load, the control method is provided with: an obtaining process of obtaining input impedance associated with the constant voltage circuit; and a controlling process of calculating an output adjustment value associated with the power supply on the basis of the obtained input impedance and of transmitting the calculated output adjustment value to the power transmitting apparatus.

The above object of the present invention can be achieved by a computer program for making a computer function as an obtaining device and a controlling device, the computer being mounted on a wireless power reception system is provided with: (i) a power reception antenna configured to receive, in a wireless manner, electric power outputted from a power transmission antenna of a power transmitting apparatus, which comprises a power supply and the power transmission antenna electrically connected to the power supply; (ii) a rectifier electrically connected between the power reception antenna and a load, the load being supplied with the electric power received by the power reception antenna; and (iii) a constant voltage circuit electrically connected between the rectifier and the load, the obtaining device being configured to obtain input impedance associated with the constant voltage circuit; and the controlling device being configured to calculate an output adjustment value associated with the power supply on the basis of the obtained input impedance and to transmit the calculated output adjustment value to the power transmitting apparatus.

The above object of the present invention can be achieved by a recording medium on which the computer program according to the present invention is recorded.

The operation and other advantages of the present invention will become more apparent from embodiments and examples explained below.

### BRIEF DESCRIPTION OF DRAWINGS

FIG. 1 is a block diagram illustrating a configuration of a wireless power transmission system according to an example.

FIG. 2 is a characteristic diagram illustrating one example of transmission efficiency characteristics.

FIG. 3 is a circuit diagram illustrating a DC-DC converter using a step-down chopper.

FIG. 4 is a characteristic diagram illustrating one example of a relation between input voltage and input impedance associated with the DC-DC converter, for each varying load.

FIG. 5 is a flowchart illustrating a transmitted power control process performed in the wireless power transmission system according to the example.

FIG. 6 is a block diagram illustrating a configuration of a wireless power transmission system according to a first modified example of the example.

FIG. 7 is a block diagram illustrating a configuration of a wireless power transmission system according to a second modified example of the example.

FIG. 8 is a block diagram illustrating a configuration of a wireless power transmission system according to a third modified example of the example.

### DESCRIPTION OF EMBODIMENTS

The wireless power reception system, the wireless power transmission system, the control method, the computer program, and the recording medium according to embodiments of the present invention will be explained.

(Wireless Power Reception System)

A wireless power reception system according to an embodiment is provided with a power reception antenna, a rectifier, a constant voltage circuit, an obtaining device, and a controlling device.

The power reception antenna is configured to receive, in a wireless or noncontact manner, electric power outputted from a power transmission antenna of a power transmitting apparatus, which is provided with a power supply and the power transmission antenna electrically connected to the power supply.

The rectifier is electrically connected between the power reception antenna and a load, the load being supplied with the electric power received by the power reception antenna (e.g. a battery, etc.). The constant voltage circuit, such as, for example, a DC-DC converter and a three-terminal regulator, is electrically connected between the rectifier and the load.

The obtaining device obtains input impedance associated with the constant voltage circuit. As a method of obtaining the input impedance, for example, an input current value and an input voltage value associated with the constant voltage circuit may be measured and the measured input voltage value may be divided by the measured input current value to obtain the input impedance.

The controlling device, such as, for example, a memory and a processor, calculates an output adjustment value associated with the power supply of the power transmitting apparatus on the basis of the obtained input impedance, and transmits the calculated output adjustment value to the power transmitting apparatus.

According to the study of the present inventors, it has been found that even if the load electrically connected to a later stage of the rectifier changes, the input impedance associated with the constant voltage circuit can be kept constant by changing the input voltage value associated with the constant voltage circuit according to the change in the load (refer to an example described later for the details).

Therefore, as described above, if the output adjustment value calculated by the controlling device is transmitted to the power transmitting apparatus, and as a result, if the power supply is controlled according to the transmitted output adjustment value (i.e. if feedback control is performed according to the input impedance), the input voltage value associated with the constant voltage value changes, and the input impedance can be kept constant.

As a result, according to the wireless power reception system in the embodiment, the constant voltage output characteristics can be maintained even if the load changes.

In one aspect of the wireless power reception system according to the embodiment, the controlling device calculates the output adjustment value that allows the input impedance to approach a predetermined value, on the basis of the obtained input impedance.

According to this aspect, the input impedance can be kept constant (at the predetermined value), relatively easily. Here, the “predetermined value” may be set, on the basis of a variable range of circuit resistance on an output side of the constant voltage circuit caused by the change in the load during power transmission, as a value that allows the constant voltage output characteristics to be maintained in the variable range.

In this aspect, the controlling device may calculate a difference between the obtained input impedance and an input impedance target value, which is the predetermined value, and may calculate the output adjustment value that approaches the calculated difference to approach zero.

(Wireless Power Transmission System)

A wireless power transmission system according to an embodiment is provided with a power transmitting apparatus and a power receiving apparatus electrically connected to a load, such as, for example, a battery.

The power transmitting apparatus is provided with: a power supply; a power transmission antenna electrically connected to the power supply; and a power supply controlling device configured to control the power supply.

The power receiving apparatus is provided with: a power reception antenna; a rectifier; a constant voltage circuit; an obtaining device configured to obtain input impedance associated with the constant voltage circuit; and a controlling device configured to calculate an output adjustment value associated with the power supply on the basis of the obtained input impedance and to transmit the calculated output adjustment value to the power transmitting apparatus.

Particularly, here, the power supply controlling device of the power transmitting apparatus controls the power supply on the basis of the output adjustment value transmitted from the power receiving apparatus.

According to the wireless power transmission system in the embodiment, as in the wireless power reception system in the embodiment described above, the constant voltage output characteristics can be maintained even if the load changes.

The wireless power transmission system according to the embodiment can also adopt the same various aspects as those of the wireless power reception system in the embodiment described above.

(Control Method)

A control method according to an embodiment is a control method in a wireless power reception system comprising: (i) a power reception antenna configured to receive, in a wireless manner, electric power outputted from a power transmission antenna of a power transmitting apparatus, which comprises a power supply and the power transmission antenna electrically connected to the power supply; (ii) a rectifier electrically connected between the power reception antenna and a load, the load being supplied with the electric power received by the power reception antenna; and (iii) a constant voltage circuit electrically connected between the rectifier and the load.

The control method is provided with: an obtaining process of obtaining input impedance associated with the constant voltage circuit; and a controlling process of calculating an output adjustment value associated with the power supply on the basis of the obtained input impedance and of transmitting the calculated output adjustment value to the power transmitting apparatus.

According to the control method in the embodiment, as in the wireless power reception system in the embodiment described above, the constant voltage output characteristics can be maintained even if the load changes.

The control method according to the embodiment can also adopt the same various aspects as those of the wireless power reception system in the embodiment described above.

(Computer Program)

A computer program according to an embodiment makes a computer function as an obtaining device and a controlling device, the computer being mounted on a wireless power reception system comprising: (i) a power reception antenna configured to receive, in a wireless manner, electric power outputted from a power transmission antenna of a power transmitting apparatus, which comprises a power supply and the power transmission antenna electrically connected to the power supply; (ii) a rectifier electrically connected between the power reception antenna and a load, the load being supplied with the electric power received by the power reception antenna; and (iii) a constant voltage circuit electrically connected between the rectifier and the load, the obtaining device being configured to obtain input impedance associated with the constant voltage circuit; and the controlling device being configured to calculate an output adjustment value associated with the power supply on the basis of the obtained input impedance and to transmit the calculated output adjustment value to the power transmitting apparatus.

According to the computer program in the embodiment, the wireless power reception system according to the embodiment described above can be relatively easily realized as the computer provided in the wireless power reception system reads and executes the computer program from a recording medium for storing the computer program, such as a random access memory (RAM), a compact disc read only memory (CD-ROM) and a DVD read only memory (DVD-ROM), or as it executes the computer program after downloading the program through a communication device. By this, as in the wireless power reception system according to the embodiment described above, the constant voltage output characteristics can be maintained even if the load changes.

### Example

A wireless power transmission system according to an example of the present invention will be explained on the basis of the drawings.

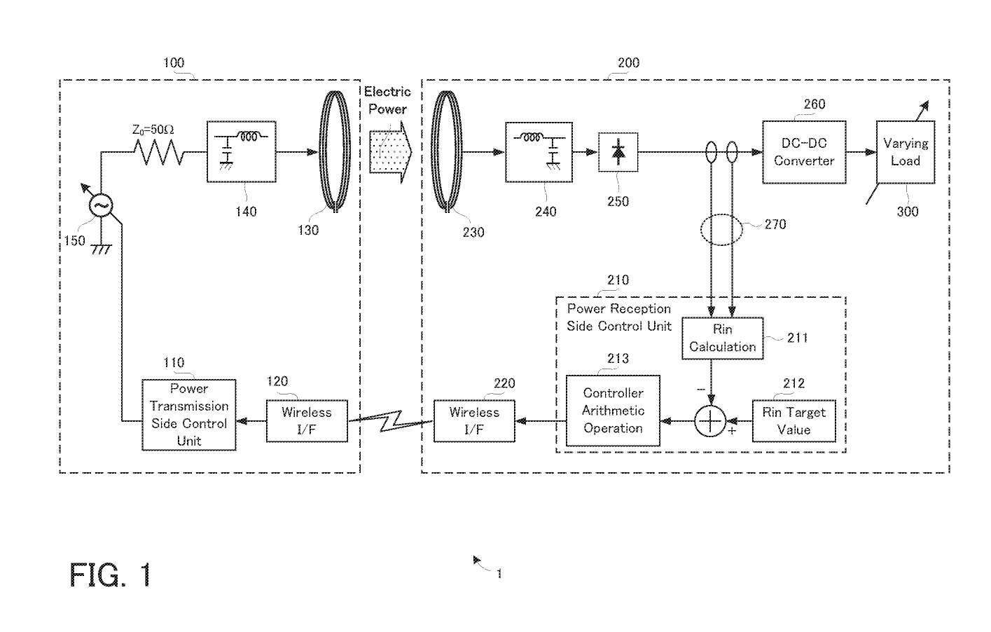

A configuration of the wireless power transmission system according to the example will be explained with reference to FIG. 1. FIG. 1 is a block diagram illustrating the configuration of the wireless power transmission system according to the example.

In FIG. 1, a wireless power transmission system 1 is provided with a power transmitting apparatus 100 and a power receiving apparatus 200. In the example, wireless power transmission by magnetic resonant coupling is performed between the power transmitting apparatus 100 and the power receiving apparatus 200.

The power transmitting apparatus 100 is provided with a power transmission side control unit 110, a wireless interface 120, a power transmission antenna 130, a matching circuit 140, and a high-frequency power supply apparatus 150. “Z₀” in FIG. 1 indicates characteristic impedance of the high-frequency power supply apparatus 150.

The power receiving apparatus 200 is provided with a power reception side control unit 210, a wireless interface 220, a power reception antenna 230, a matching circuit 240, a rectifier 250, a DC-DC converter 260, and a voltage/current monitoring unit 270. The DC-DC converter 260 is electrically connected to a varying load 300 in which a load varies depending on a charging state, such as, for example, a battery.

Here, the wireless power transmission system 1 using the magnetic resonance coupling has such characteristics that electric power transmission efficiency varies depending on the value of a load electrically connected to a later stage of the power reception antenna 230 of the power receiving apparatus 200 (which will be hereinafter referred to as a “circuit load” as occasion demands, to prevent confusion with the “varying load 300”).

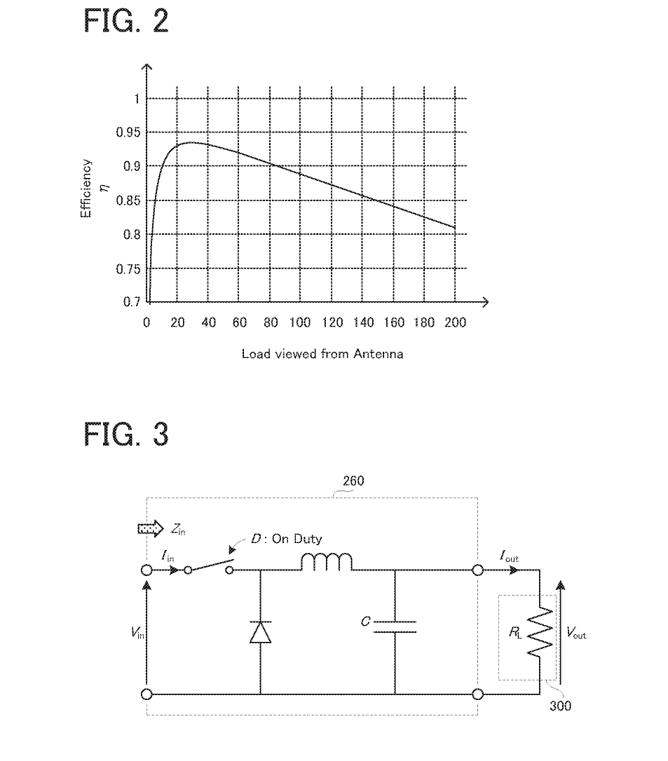

The transmission efficiency characteristics will be specifically explained with reference to FIG. 2. FIG. 2 is a characteristic diagram illustrating one example of the transmission efficiency characteristics. The characteristics illustrated in FIG. 2 are characteristics when Q values and loss resistance r associated with the power transmission antenna 130 and the power reception antenna 230 are respectively 700 and 1.0Ω, and a coupling coefficient between the power transmission antenna 130 and the power reception antenna 230 is 0.0423.

As is seen from FIG. 2, there is a circuit load having maximum transmission efficiency (refer to a horizontal axis in FIG. 2). The circuit load having the maximum transmission efficiency is referred to as an “optimal load”. The optimal load varies depending on the Q value and the loss resistance r associated with the antenna to be used (i.e. the power transmission antenna and the power reception antenna), and the coupling coefficient k. In other words, if the Q value and the loss resistance r associated with the antenna and the coupling coefficient k are known, the optimal load can be obtained in advance. Therefore, in order to perform power transmission with relatively high efficiency, the circuit load is set to be the optimal load.

Moreover, if the magnetic resonance coupling is used, as in the wireless power transmission system 1, the matching circuit is provided for each of the power transmitting apparatus 100 and the power receiving apparatus 200 (or is provided for one of the power transmitting apparatus and the power receiving apparatus) to perform impedance conversion or impedance matching, in many cases.

By the way, an electronic circuit electrically connected to the power receiving apparatus 200 as the varying load 300 (e.g. various processing circuits that operate at a power supply voltage of 12V or 5V or the like) stably operates by being supplied with predetermined voltage of electric power. Thus, a constant voltage output function is required for the wireless power transmission system 1. Therefore, the power receiving apparatus 200 is provided with the DC-DC converter 260 having the constant voltage output function.

As a circuit having the constant voltage output function, except the DC-DC converter, for example, a three-terminal regulator or the like is known; however, the DC-DC converter is used in many cases from the viewpoint of power consumption.

It is guaranteed that the voltage on an output side of the DC-DC converter 260 (i.e. on a side on which the varying load 300 is electrically connected) is constant even if the value of the varying load 300 changes.

On the other hand, at least one of the voltage and current on an input side of the DC-DC converter 260 (i.e. on a side on which the rectifier 250 is electrically connected) changes due to the change in the value of the varying load 300. As a result, the change in the value of the varying load 300 changes a load located after the rectifier 250, by which the power transmission with the aforementioned optimal load (i.e. with the maximum efficiency) cannot be performed.

Moreover, as in the power transmitting apparatus 100, if the matching circuit 140 is provided between the high-frequency power supply apparatus 150 and the power transmission antenna 130, and if the power transmission is performed after the impedance matching, when the value of the load on the power reception side changes, the input impedance associated with the power transmission antenna 130 also changes. Then, the high-frequency power supply apparatus 150 and the power transmission antenna 130 become in an impedance mismatching state to cause a power loss (i.e. a reflection loss).

In order to solve the impedance mismatching state, for example, changing a circuit constant associated with the matching circuit 140 can be considered. However, as the matching circuit 140, a variable impedance matching circuit having a variable inductor and a variable capacitor needs to be used, which cause such technical problems as an increase in apparatus size and complicated control.

With respect to the technical problems described above, for example, in the technology described in the Patent Literature 1, the duty of the DC-DC converter 260 is controlled so that the input impedance associated with the DC-DC converter 260 is constant. As a result, even if the value of the varying load 300 changes, the load located after the rectifier 250 is constant, and it is possible to prevent the impedance mismatching state of the power transmitting apparatus 100.

Here, the technical problems caused by changing the duty of the DC-DC converter 260 will be explained with reference to FIG. 3. FIG. 3 is a circuit diagram illustrating a DC-DC converter using a step-down chopper.

The operation of the DC-DC converter 260 illustrated in FIG. 3 is described by the following three equations if there is no internal loss. “D” means “On Duty”. “R_{L}” is a value of the varying load 300.

Vₒᵤₜ=DVᵢₙ [Equation 1]

VᵢₙIᵢₙ=VₒᵤₜIₒᵤₜ [Equation 2]

Vₒᵤₜ=R_{L}Iₒᵤₜ [Equation 3]

From the “Equation 1” and the “Equation 2”, a relation between input current Iᵢₙ, and output current Iₒᵤₜ associated with the DC-DC converter 260 is obtained as in the following equation.

$$\frac{{V}_{out}}{D} {I}_{in} = {V}_{out} {I}_{out} ∴ {I}_{in} = {DI}_{out} \qquad [ Equation 4 ]$$

From the “Equation 1” to the “Equation 4”, input impedance Zᵢₙ=(=Vᵢₙ/Iᵢₙ) associated with the DC-DC converter 260 is as in the following equation.

$${Z}_{in} = \frac{{V}_{in}}{{I}_{in}} = \frac{{V}_{out}}{D} \times \frac{1}{{DI}_{out}} = \frac{1}{{D}^{2}} \times \frac{{V}_{out}}{{I}_{out}} = \frac{1}{{D}^{2}} {R}_{L} \qquad [ Equation 4 ]$$

As is clear from the “Equation 5”, the input impedance Zᵢₙ associated with the DC-DC converter 260 can be changed by changing the duty of the DC-DC converter 260 (i.e. “D”) (whose characteristics are used by the technology described in the Patent Literature 1).

As is clear from the “Equation 1”, however, if the input voltage Vᵢₙ associated with the DC-DC converter 260 is constant, when the duty changes, the output voltage Vₒᵤₜ changes. In other words, the constant voltage output function of the DC-DC converter 260 is lost.

Thus, if the output voltage Vₒᵤₜ is set to be a constant Kᵥₒ (i.e. Vₒᵤₜ=Kᵥₒ) and if that is applied to the “Equation 1” and the “Equation 3”, then, the following equation is obtained.

$$\begin{matrix}D = \frac{{K}_{VO}}{{V}_{in}} & [ Equation 6 ] \\ {I}_{out} = \frac{{K}_{VO}}{{R}_{L}} & [ Equation 7 ]\end{matrix}$$

If the “Equation 6” and the “Equation 7” are used to arrange the equation associated with the input impedance Zᵢₙ so that a duty item is deleted from the “Equation 5”, then, the following equation is obtained.

$${Z}_{in} = \frac{{V}_{in}}{{I}_{in}} = \frac{{V}_{in}}{{DI}_{out}} = {V}_{in} \times \frac{{V}_{in}}{{K}_{VO}} \times \frac{{R}_{L}}{{K}_{VO}} = {( \frac{{V}_{in}}{{K}_{VO}} )}^{2} {R}_{L} \qquad [ Equation 8 ]$$

As is clear from this equation, the input impedance Zᵢₙ can be changed regardless of the duty by changing the input voltage Vᵢₙ.

Thus, in the wireless power transmission system 1, firstly, on the power reception side control unit 210, an estimated resistance value Rᵢₙ of the input impedance Zᵢₙ associated with the DC-DC converter 260 is calculated on the basis of the input voltage Vᵢₙ and the input current Iᵢₙ measured by the voltage/current monitoring unit 270 (refer to a reference numeral 211 in FIG. 1).

Then, an output adjustment value associated with the high-frequency power supply apparatus 150 is arithmetically operated on the basis of the calculated estimated resistance value Rᵢₙ and a target resistance value R_{ref} of the input impedance Zᵢₙ (refer to a reference numeral 212 in FIG. 1) by a controller arithmetic operation unit 213 of the power reception side control unit 210. Specifically, for example, the controller operation unit 213 obtains a difference between the calculated estimated resistance value Rᵢₙ and the target resistance value R_{ref} and arithmetically operates the output adjustment value that allows the obtained difference to approach zero.

Now, the target resistance value R_{ref} will be explained with reference to FIG. 4. FIG. 4 is a characteristic diagram illustrating one example of a relation between the input voltage and the input impedance associated with the DC-DC converter, for each varying load.

As illustrated in FIG. 4, the input impedance Zᵢₙ of the DC-DC converter 260 that can be kept constant in a variation range of the varying load 300 (which is here 30Q to 80Q) is, for example, 50Ω. As described above, the input impedance Zᵢₙ that can be kept constant in the variation range of the varying load 300 may be set as the target resistance value R_{ref}.

The output adjustment value arithmetically operated by the controller arithmetic operation unit 213 is transmitted to the power transmitting apparatus 100 via the wireless interface 220. The power transmission side control unit 110 of the power transmitting apparatus 100 controls the high-frequency power supply apparatus 150 on the basis of the transmitted output adjustment value. As a result, the input voltage Vᵢₙ associated with the DC-DC converter 260 changes so that the input impedance Zᵢₙ approaches a target value.

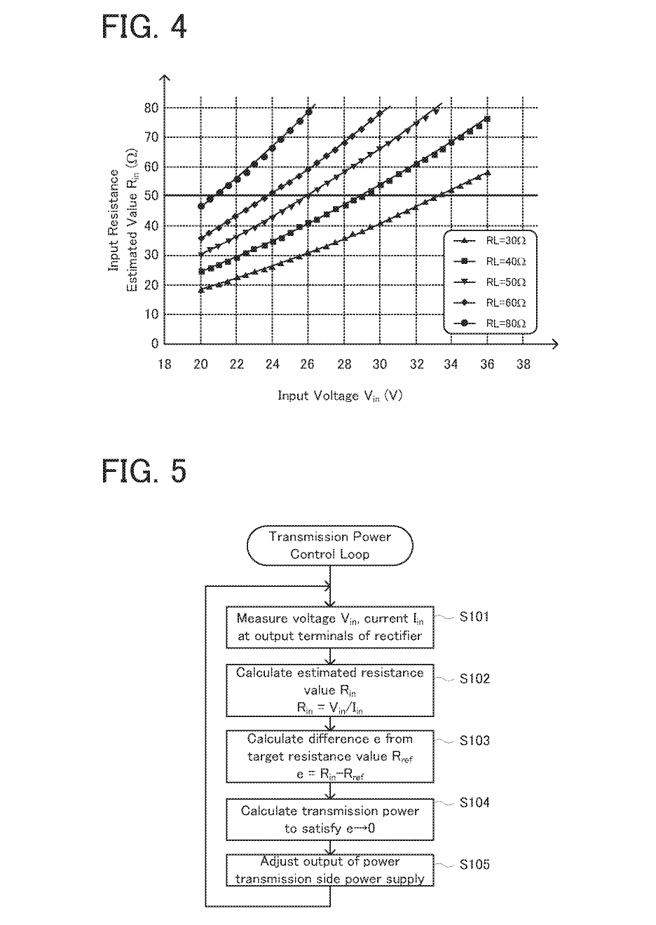

A transmission power control process performed in the wireless power transmission system 1 as configured above will be explained with reference to a flowchart in FIG. 5.

In FIG. 5, firstly, the voltage/current monitoring unit 270 of the power receiving apparatus 200 measures voltage Vᵢₙ and current Iᵢₙ on an output side of the rectifier 250 of the power receiving apparatus 200 (in other words, on an input side of the DC-DC converter 260) (step S101).

Then, the power reception side control unit 210 of the power receiving apparatus 200 calculates the estimated resonance value Rᵢₙ on the basis of the measured voltage Vᵢₙ and current Iᵢₙ (step S102). Then, the power reception side control unit 210 calculates a difference e between the calculated estimated resonance value Rᵢₙ and the target resonance value R_{ref} (step S103).

Then, the power reception side control unit calculates the output adjustment value associated with the high-frequency power supply apparatus 150 such that the difference e approaches zero (step S104). The calculated output adjustment value is transmitted to the power transmission side control unit 110 of the power transmitting apparatus 100 via the wireless interfaces 220 and 120.

The power transmission side control unit 110 controls the high-frequency power supply apparatus 150 on the basis of the transmitted output adjustment value (step S105).

In the wireless power transmission system 1 according to the example, as described above, the output of the high-frequency power supply apparatus 150 (i.e. the input voltage Vᵢₙ associated with the DC-DC converter 260) is changed, by which the load at an output terminal of the rectifier 250 of the power receiving apparatus 200 becomes constant or substantially constant even if the value of the varying load 300 varies. Therefore, even if the value of the varying load 300 varies, the power transmission with the maximum efficiency can be performed without changing the constant of the matching circuit and with satisfying a condition for the optimal load associated with the power transmission antenna 130 and the power reception antenna 230.

In particular, it is not necessary to use the variable impedance matching circuit as the matching circuit, and it is thus possible to miniaturize and lighten the power transmitting apparatus 100 and the power receiving apparatus 200 that constitute the wireless power transmission system 1, which is extremely useful in practice.

The “power transmission side control unit 110”, the “power receiving apparatus 200”, and the “DC-DC converter 260” according to the example are respectively one example of the “power supply controlling device”, the “wireless power reception system”, and the “constant voltage circuit” according to the present invention. The “power reception side control unit 210” according to the example is one example of the “obtaining device” and the “controlling device” according to the present invention.

### First Modified Example

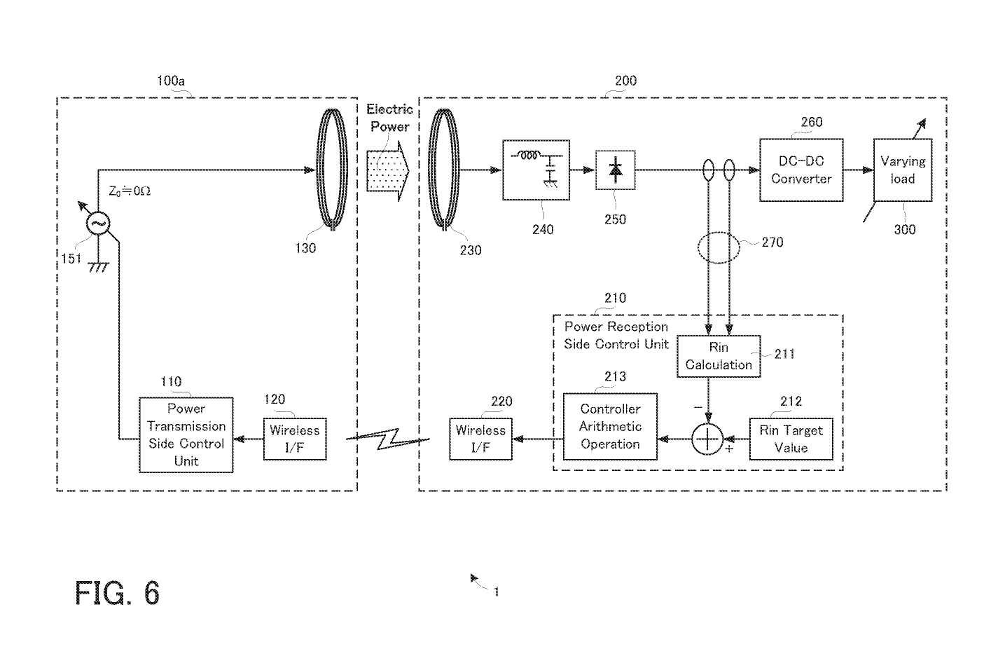

A first modified example of the wireless power transmission system 1 according to the example will be explained with reference to FIG. 6. FIG. 6 is a block diagram illustrating a configuration of the wireless power transmission system according to the first modified example of the example.

In FIG. 6, the wireless power transmission system 1 is provided with a power transmitting apparatus 100a and the power receiving apparatus 200. Here, the power transmitting apparatus 100a is provided with a high-frequency power supply apparatus 151 having output impedance Zₒ that is low enough to be ignored.

In this case, it is not necessary to provide the impedance matching circuit between the high-frequency power supply apparatus 151 and the power transmission antenna 130. Therefore, as illustrated in FIG. 6, the power transmitting apparatus 100a can be configured not to be provided with the impedance matching circuit.

### Second Modified Example

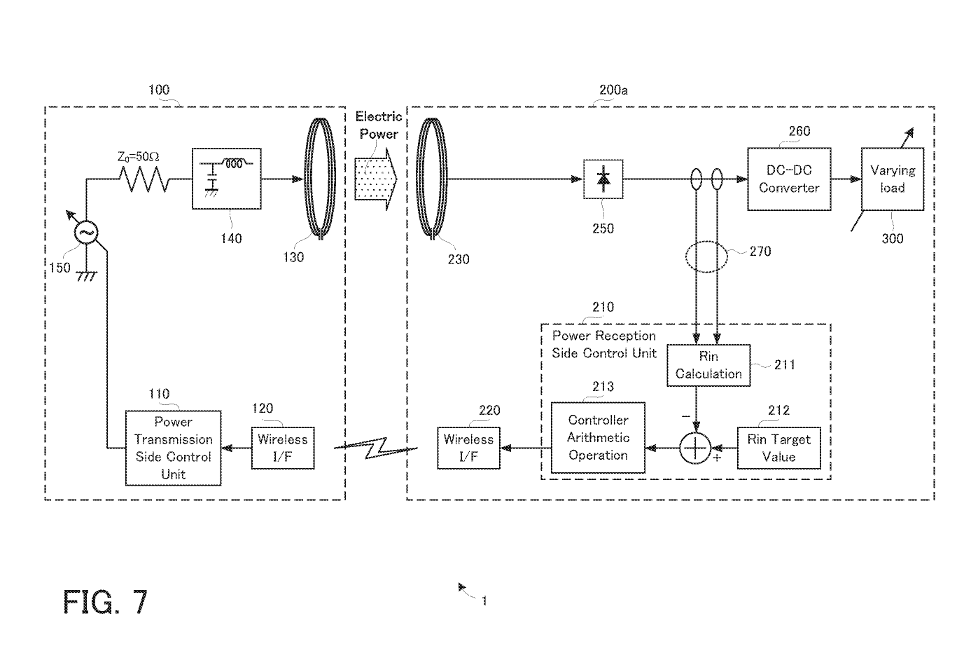

A second modified example of the wireless power transmission system 1 according to the example will be explained with reference to FIG. 7. FIG. 7 is a block diagram illustrating a configuration of the wireless power transmission system according to the second modified example of the example.

In FIG. 7, the wireless power transmission system 1 is provided with the power transmitting apparatus 100 and a power receiving apparatus 200a.

If it is not necessary to perform the impedance matching between the optima load associated with the power reception antenna 230 and the input impedance associated with the rectifier 250, then, as illustrated in FIG. 7, the power receiving apparatus 200a can be configured not to be provided with the impedance matching circuit.

### Third Modified Example

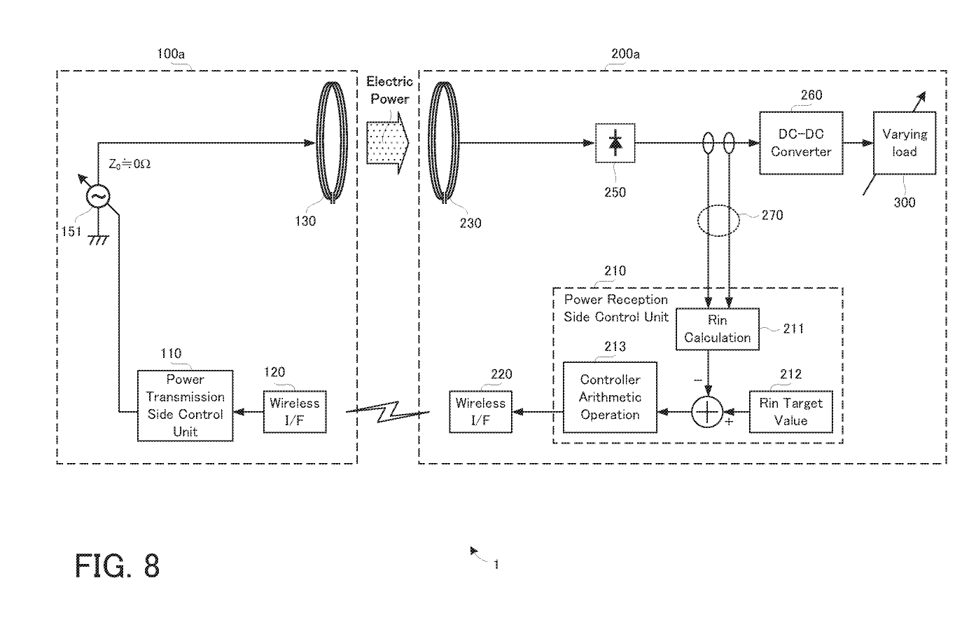

A third modified example of the wireless power transmission system 1 according to the example will be explained with reference to FIG. 8. FIG. 8 is a block diagram illustrating a configuration of the wireless power transmission system according to the third modified example of the example.

In FIG. 8, the wireless power transmission system 1 is provided with the power transmitting apparatus 100a and the power receiving apparatus 200a.

If the power transmitting apparatus 100a is provided with the high-frequency power supply apparatus 151 having the output impedance Zₒ that is low enough to be ignored, and if it is not necessary to perform the impedance matching between the optima load associated with the power reception antenna 230 and the input impedance associated with the rectifier 250, then, as illustrated in FIG. 8, both of the power transmitting apparatus 100a and the power receiving apparatus 200a can be configured not to be provided with the impedance matching circuit.

The present invention is not limited to the aforementioned embodiment and example, but various changes may be made, if desired, without departing from the essence or spirit of the invention which can be read from the claims and the entire specification. A wireless power reception system, a control method, a computer program, and a wireless power transmission system which involve such changes are also intended to be within the technical scope of the present invention.

### DESCRIPTION OF REFERENCE NUMERALS AND LETTERS

1 wireless power transmission system
100, 100a power transmitting apparatus
110 power transmission side control unit
120, 220 wireless interface
130 power transmission antenna
140, 240 matching circuit
150, 151 high-frequency power supply apparatus
200, 200a power receiving apparatus
210 power reception side control unit
230 power reception antenna
250 rectifier
260 DC-DC converter
270 voltage/current monitoring unit
300 varying load

1. A wireless power reception system comprising:
a power reception antenna configured to receive, in a wireless manner, electric power outputted from a power transmitting apparatus, which comprises a power transmission antenna electrically connected to a power supply;
a load supplied with the electric power received by the power reception antenna;
a constant voltage circuit provided before the load;
an obtaining device configured to obtain input impedance associated with the constant voltage circuit; and
a controlling device configured to calculate an output adjustment value for adjusting output of the power supply on the basis of the obtained input impedance and to transmit the calculated output adjustment value to the power transmitting apparatus.

2. The wireless power reception system according to claim 1, wherein the controlling device calculates the output adjustment value that allows the input impedance to approach a predetermined value, on the basis of the obtained input impedance.

3. The wireless power reception system according to claim 2, wherein the controlling device calculates a difference between the obtained input impedance and an input impedance target value, which is the predetermined value, and calculates the output adjustment value that approaches the calculated difference to approach zero.

4. The wireless power reception system according to claim 1, wherein the constant voltage circuit is a DC-DC converter.

5. A wireless power transmission system comprising a power transmitting apparatus and a power receiving apparatus electrically connected to a load, wherein
the power transmitting apparatus comprises:
a power supply;
a power transmission antenna electrically connected to the power supply; and
a power supply controlling device configured to control the power supply,
the power receiving apparatus comprises:
a power reception antenna configured to receive, in a wireless manner, electric power outputted from the power transmission antenna;
a constant voltage circuit provided before the load and electrically connected to the load;
an obtaining device configured to obtain input impedance associated with the constant voltage circuit; and
a controlling device configured to calculate an output adjustment value for adjusting output of the power supply on the basis of the obtained input impedance and to transmit the calculated output adjustment value to the power transmitting apparatus, and
the power supply controlling device controls the power supply on the basis of the transmitted output adjustment value.

6. A control method in a wireless power reception system comprising: a power reception antenna configured to receive, in a wireless manner, electric power outputted from a power transmission antenna of a power transmitting apparatus, which comprises the power transmission antenna electrically connected to a power supply; and a constant voltage circuit provided before a load, the load being supplied with the electric power received by the power reception antenna, the control method comprising:
an obtaining process of obtaining input impedance associated with the constant voltage circuit; and
a controlling process of calculating an output adjustment value for adjusting output of the power supply on the basis of the obtained input impedance and of transmitting the calculated output adjustment value to the power transmitting apparatus.

7-8. (canceled)
